(19) United States
(12) Patent Application Publication
(10) Pub. No.: US 2022/0206434 A1
(43) Pub. Date: Jun. 30, 2022

(54) SYSTEM AND METHOD FOR DEEP LEARNING-BASED COLOR HOLOGRAPHIC MICROSCOPY

(71) Applicant: THE REGENTS OF THE UNIVERSITY OF CALIFORNIA, Oakland, CA (US)

(72) Inventors: Aydogan Ozcan, Los Angeles, CA (US); Yair Rivenson, Los Angeles, CA (US); Tairan Liu, Los Angeles, CA (US); Yibo Zhang, Los Angeles, CA (US); Zhensong Wei, Los Angeles, CA (US)

(73) Assignee: THE REGENTS OF THE UNIVERSITY OF CALIFORNIA, Oakland, CA (US)

(21) Appl. No.: 17/604,416

(22) PCT Filed: Apr. 21, 2020
(86) PCT No.: PCT/US2020/029157

§ 371 Date: Oct. 17, 2021

Related U.S. Application Data
(60) Provisional application No. 62/837,066, filed on Apr. 22, 2019.

(51) Int. Cl. G03H 1/08; G03H 1/04; G03H 1/26; G06N 3/08; G06N 3/04

(52) U.S. Cl. CPC G03H 1/0866; G03H 1/0443; G03H 1/0808; G03H 2001/005; G06N 3/084; G06N 3/0454; G03H 1/2645

(57) ABSTRACT

A method for performing color image reconstruction of a single super-resolved holographic sample image includes obtaining a plurality of sub-pixel shifted lower resolution hologram images of the sample using an image sensor by simultaneous illumination at multiple color channels. Super-resolved hologram intensity images for each color channel are digitally generated based on the lower resolution hologram images. The super-resolved hologram intensity images for each color channel are back propagated to an object plane with image processing software to generate a real and imaginary input images of the sample for each color channel. A trained deep neural network is provided and is executed by image processing software using one or more processors of a computing device and configured to receive the real input image and the imaginary input image of the sample for each color channel and generate a color output image of the sample.

### RELATED APPLICATION

This Application claims priority to U.S. Provisional Patent Application No. 62/837,066 filed on Apr. 22, 2019, which is hereby incorporated by reference in its entirety. Priority is claimed pursuant to 35 U.S.C. § 119 and any other applicable statute.

### STATEMENT REGARDING FEDERALLY SPONSORED RESEARCH AND DEVELOPMENT

This invention was made with government support under Grant Number EEC 1648451, awarded by the National Science Foundation. The government has certain rights in the invention.

### TECHNICAL FIELD

The technical field generally relates methods and systems used to perform high-fidelity color image reconstruction using a single super-resolved hologram using a trained deep neural network. In particular, the system and method use a single super-resolved hologram obtained of a sample that is simultaneously illuminated at multiple different wavelengths as the input to the trained deep neural network which outputs a high-fidelity color image of the sample.

### BACKGROUND

Histological staining of fixed, thin tissue sections mounted on glass slides is one of the fundamental steps required for the diagnoses of various medical conditions. Histological stains are used to highlight the constituent tissue parts by enhancing the colorimetric contrast of cells and subcellular components for microscopic inspection. Thus, an accurate color representation of the stained pathology slide is an important prerequisite to make reliable and consistent diagnoses. Unlike brightfield microscopy, another method used to obtain color information from a sample using a coherent imaging system requires the acquisition of at least three holograms at the red, green, and blue parts of the visible light spectrum, thus forming the red-green-blue (RGB) color channels that are used to reconstruct composite color images. Such colorization methods used in coherent imaging systems suffer from color inaccuracies, however, and may be considered unacceptable for histopathology and diagnostic applications.

To achieve increased color accuracy using coherent imaging systems, a computational hyperspectral imaging approach can be used. However, such systems typically require engineered illumination, such as a tunable laser to efficiently sample the visible band. Previous contributions have demonstrated successful reduction in the number of required sampling locations for the visible band to generate accurate color images. For example, Peercy et at demonstrated a wavelength selection method using Gaussian quadrature or Riemann summation for reconstructing color images of a sample imaged in reflection mode holography, whereby it was suggested that a minimum of four wavelengths were required to generate accurate color images of natural objects. See Peercy et al., Wavelength selection for true-color holography, Applied Optics 33, 6811-6817 (1994).

Later, it was demonstrated a Wiener estimation-based method to quantify the spectral reflectance distribution of the object at four fixed wavelengths that achieved an increased color accuracy for natural objects. See P. Xia et al., Digital Holography Using Spectral Estimation Technique, J. Display Technol., JDT 10, 235-242 (2014), More recently, Zhang et al. presented an absorbance spectrum estimation method based on minimum mean-square-error estimation, specifically crafted to create accurate color images of pathology slides with in-line holography. See Zhang et al., Accurate color imaging of pathology slides using holography and absorbance spectrum estimation of histochemical stains, Journal of Biophotonics e201800335 (2018). Because the color distribution within a stained histopathology slide is constrained by the colorimetric dye combination that is used, this method successfully reduced the required number of wavelengths to three while still preserving accurate color representation. However, owing to the distortions introduced. by twin image artifacts and the limited resolution of unit magnification on-chip holography systems, multi-height phase recovery and pixel super-resolution (PSR) techniques were implemented to achieve acceptable image quality. In the method of Zhang et al., four (or more) super-resolved holograms are collected at four different sample-to-sensor (z) distances. This requires a moveable stage that not only allows for lateral (x, y) motion used to acquire PSR images but also requires movement in the vertical or z direction to obtain the multi-height images.

### SUMMARY

In one embodiment, a deep learning-based accurate color holographic microscopy system and method is disclosed that uses a single super-resolved hologram image acquired under wavelength-multiplexed illumination (i.e., simultaneous illumination). In comparison to the traditional hyperspectral imaging approaches used in coherent imaging systems, the deep neural-network-based color microscopy system and method significantly simplifies the data acquisition procedures, the associated data processing and storage steps, and the imaging hardware. First, this technique requires only a single super-resolved hologram acquired under simultaneous illumination. Because of this, the system and method achieves a similar performance to that of the state-of-the-art absorbance spectrum estimation method of Zhang et al. that uses four super-resolved holograms collected at four sample-to-sensor distances with either sequential or multiplexed illumination wavelengths, thus representing more than four-fold enhancement in terms of data throughput. Moreover, there is no need for more complicated moveable stages that move in the z direction that add cost, complexity in design, and take additional time for obtaining color images.

The success of this method and system is demonstrated using two types of pathology slides: lung tissue sections stained with Masson's trichrome and prostate tissue sections stained with Hematoxylin and Eosin (H&E) although it should be appreciated that other stains and dyes may be used. Using both the structural similarity index (SSIM) and the color distance, high fidelity and color-accurate images are reconstructed and compared to the gold-standard images obtained using the hyperspectral imaging approach. The overall time performance of the proposed framework is also compared against a conventional 20× bright-field scanning microscope, thus demonstrating that the total image acquisition and processing times are of the same scale. This deep learning-based color imaging framework will be helpful to bring coherent microscopy techniques into use for histopathology applications.

In one embodiment, a method of performing color image reconstruction of a single super-resolved holographic image of a sample includes obtaining a plurality of sub-pixel shifted lower resolution hologram intensity images of the sample using an image sensor by simultaneous illumination of the sample at a plurality of color channels. Super-resolved hologram intensity images for each of the plurality of color channels are then digitally generated based on the plurality of sub-pixel shifted lower resolution hologram intensity images. The super-resolved hologram intensity images for each of the plurality of color channels are back propagated to an object plane with image processing software to generate an amplitude input image and a phase input image of the sample for each of the plurality of color channels. A trained deep neural network is provided that is executed by image processing software using one or more processors of a computing device and configured to receive the amplitude input image and the phase input image of the sample for each of the plurality of color channels and output a color output image of the sample.

In another embodiment, a system for performing color image reconstruction of a super-resolved holographic image of a sample includes: a computing device having image processing software executed thereon, the image processing software comprising a trained deep neural network that is executed using one or more processors of the computing device. The trained deep neural network is trained with a plurality of training images or image patches from a super-resolved hologram of the image of the sample and corresponding ground truth or target color images or image patches. The image processing software (i.e., the trained deep neural network) is configured to receive one or more super-resolved holographic images of the sample generated by the image processing software from multiple low-resolution images of the sample obtained with simultaneous illumination of the sample at a plurality of illumination wavelengths and output a reconstructed color image of the sample.

In another embodiment, a system for performing color image reconstruction of a one or more super-resolved holographic image(s) of a sample includes a lensfree microscope device comprising a sample holder for holding the sample, a color image sensor, and one or more optical fiber(s) or cable(s) coupled to respective different colored light sources configured to simultaneously emit light at a plurality of wavelengths. The microscope device includes at least one of a moveable stage or an array of light sources configured to obtain sub-pixel shifted lower resolution hologram intensity images of the sample. The system further includes a computing device having image processing software executed thereon, the image processing software comprising a trained deep neural network that is executed using one or more processors of the computing device, wherein the trained deep neural network is trained with a plurality of training images or image patches from a super-resolved hologram of the image of the sample and corresponding ground truth or target color images or image patches generated from hyperspectral imaging or brightfield microscopy, the trained deep neural network configured to receive one or more super-resolved holographic images of the sample generated by the image processing software from the sub-pixel shifted lower resolution hologram intensity images of the sample obtained with simultaneous illumination of the sample and output a reconstructed color image of the sample.

### BRIEF DESCRIPTION OF THE DRAWINGS

FIG. 1A schematically illustrates a system for performing color image reconstruction of a single super-resolved holographic image of a sample according to one embodiment.

FIG. 1B illustrates an alternative embodiment that uses an illumination array to illuminate the sample. The illumination array is an alternative to the moveable stage.

FIG. 1C illustrates a process or method that is used to perform color image reconstruction of a single super-resolved holographic image of a sample according to one embodiment.

FIG. 2 schematically illustrates the process of image (data) acquisition that is used to generate the input amplitude and phase images (using, for example, red, green, blue color channels) that is input into the trained deep neural network which then outputs a reconstructed color image of the sample (a color amplitude image of pathology tissue sample is shown).

FIG. 3A-3C illustrate a. comparison between the traditional hyperspectral imaging (FIG. 3B) and the neural network-based approach (FIG. 3C) for the reconstruction of accurate color images of a sample. N_{H}, is the number of sample-to-sensor heights required for performing phase recovery, N_{W} is the number of illumination wavelengths, N_{M} is the number of measurements for each illumination condition (multiplexed or sequential), and L is the number of lateral positions used to perform pixel super resolution. FIG. 3A shows the required number of raw holograms for the traditional hyperspectral imaging and the neural network-based approach. FIG. 3B schematically illustrates the high-fidelity color image reconstruction procedure for the hyperspectral imaging approach. FIG. 3C schematically illustrates the high-fidelity color image reconstruction procedure for the neural network-based approach described herein that uses only a single super-resolved holographic image of a sample.

FIG. 4 is a schematic illustration of the generator part of the trained deep neural network. The six-channel input consists of the real and imaginary channels of the three free-space propagated holograms at three illumination wavelengths (450 nm, 540 nm, and 590 nm according to one specific implementation) resulting in a six-channel input. Each down block consists of two convolutional layers that double the number of system channels when used together. The down blocks are opposite, and consist of two convolutional layers with half the number of system channels when used together.

FIG. 5 schematically illustrates the discriminator part of the trained deep neural network. Each down block of the convolutional layer consists of two convolutional layers.

FIGS. 6A and 6B illustrate the deep learning-based accurate color imaging of a lung tissue slide stained with Masson's trichrome for a multiplexed illumination at 450 nm, 540 nm, and 590 nm, using a lens-free holographic on-chip microscope. FIG. 6A is a large field of view of the network output image (with two ROIs). FIG. 6B is a zoomed-in comparison of the network input (amplitude and phase images), the network output, and the ground truth target at ROIs 1 and 2.

FIGS. 7A and 7B illustrate the deep learning-based accurate color imaging of a prostate tissue slide stained with H&E for a multiplexed illumination at 450 nm, 540 nm, and 590 nm, using a lens-free holographic on-chip microscope. FIG. 7A is a large field of view of the network output image (with two ROIs). FIG. 7B is a zoomed-in comparison of the network input (amplitude and phase images), the network output, and the ground truth target at ROIs 1 and 2.

FIG. 8 illustrates a digitally stitched image of the deep neural network output for a lung tissue section stained with H&E, which corresponds to the image sensor's field-of-view. On the periphery of the stitched image are various ROIs of the larger image showing the output from the trained deep neural network along with the ground truth target image of the same ROI.

FIGS. 9A-9J illustrate a visual comparison between the network output image from the deep neural network-based approach and the multi-height phase recovery with spectral estimation approach like Zhang et al. for a lung tissue sample stained with Masson's trichrome. FIGS. 9A-9H show reconstruction results of spectral estimation approach using different number of heights and different illumination conditions, FIG. 9I illustrates the output image of the trained deep neural network (i.e., network output). FIG. 9J illustrates the ground truth target image obtained using the hyperspectral imaging approach.

FIGS. 10A-10J illustrate a visual comparison between the deep neural network-based approach and the multi-height phase recovery with the spectral estimation approach like Zhang et al. for a prostate tissue sample stained with H&E. FIGS. 10A-10H show reconstruction results of spectral estimation approach using different number of heights and different illumination conditions, FIG. 10I illustrates the output image of the trained deep neural network (i.e., network output). FIG. 10J illustrates the ground truth target obtained using the hyperspectral imaging approach.

### DETAILED DESCRIPTION OF THE ILLUSTRATED EMBODIMENTS

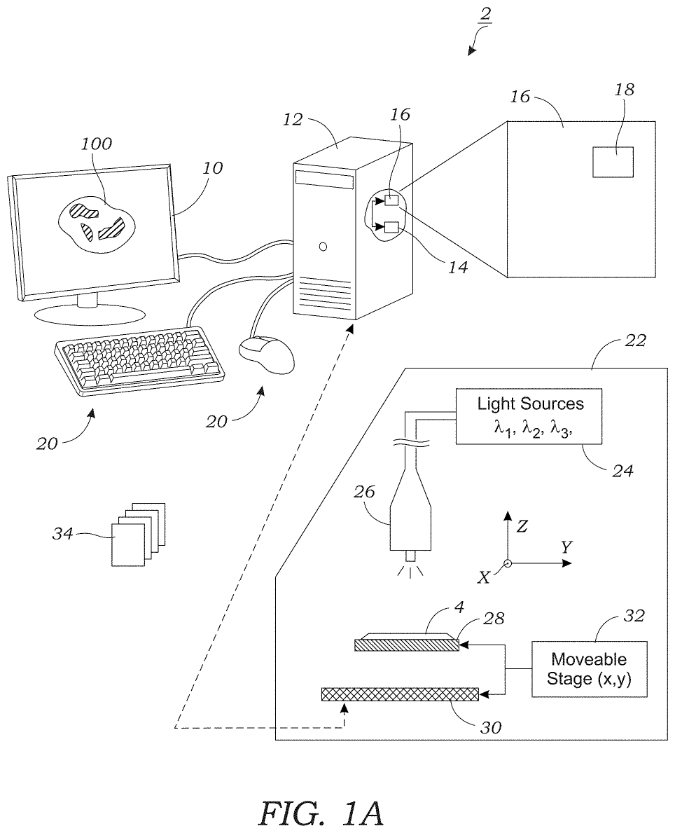

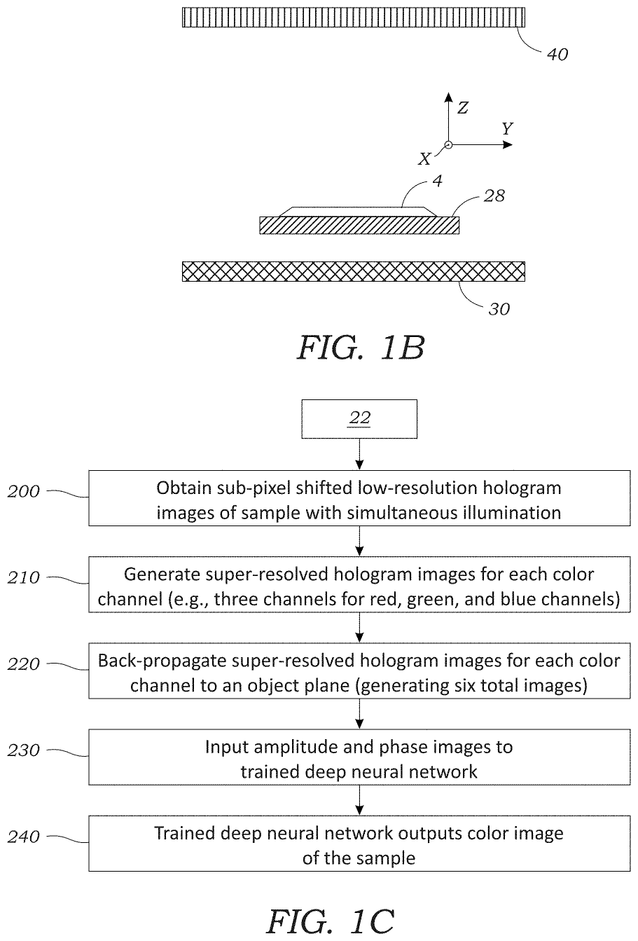

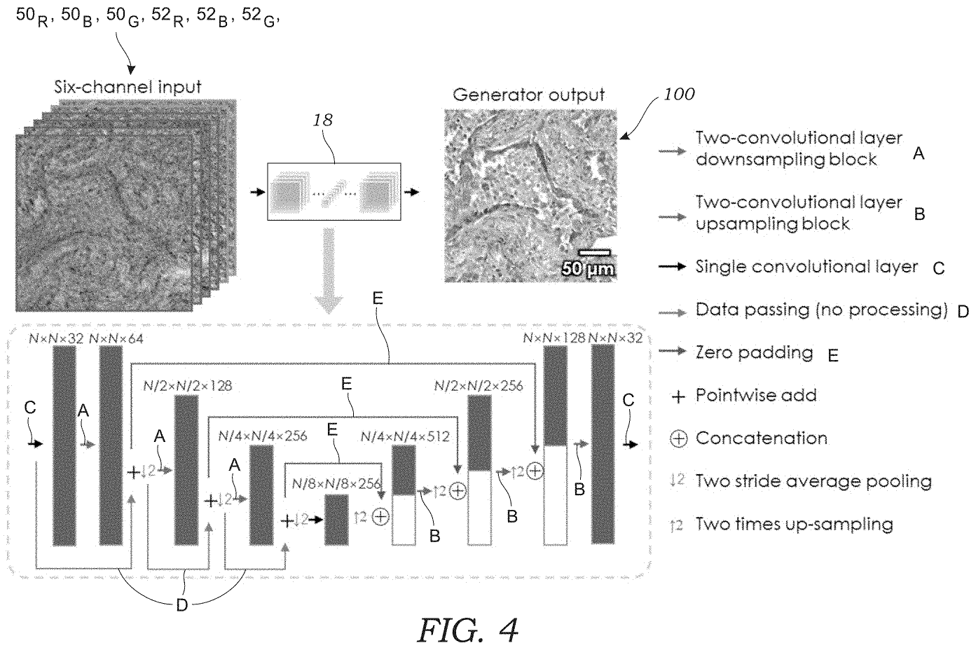

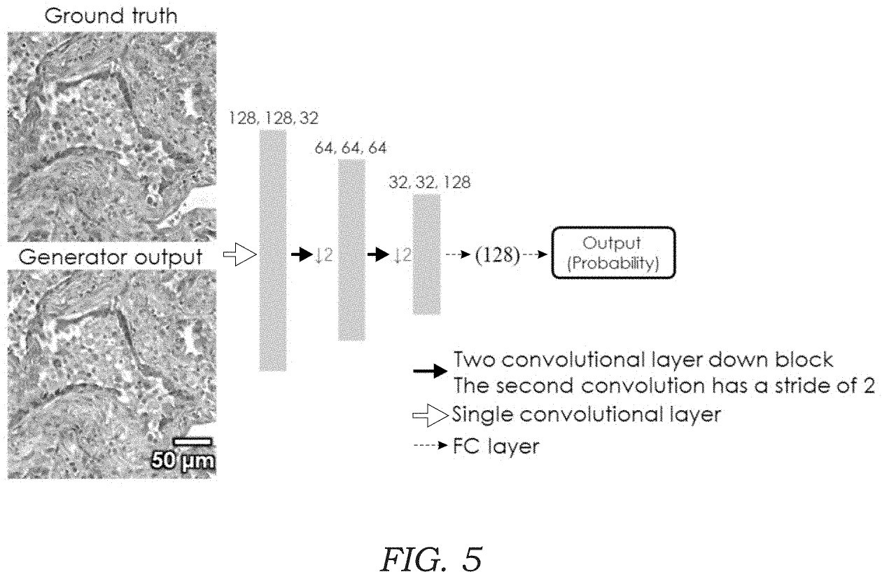

FIG. 1A schematically illustrates a system 2 that is used to generate a reconstructed color output image 100 of a sample 4. The color output image 100 may include an amplitude (real) color output image in one embodiment. Amplitude color images are typically used, for example, in histopathology imaging applications. The output color image 100 is illustrated in FIG. 1A as being displayed on a display 10 in the form of a computer monitor but it should be appreciated the color output image 100 may be displayed on any suitable display 10 (e.g., computer monitor, tablet computer or PC, mobile computing device (e.g., Smartphone, etc.). The system 2 includes a computing device 12 that contains one or more processors 14 therein and image processing software 16 that incorporates a trained deep neural network 18 (which, in one embodiment, is a generative adversarial network (GAN)-trained deep neural network). In a GAN-trained deep neural network 18, two models are used for training. A generative model (e.g., FIG. 4) is used that captures data distribution and learns color correction and elimination of missing phase-related artifacts while a second discriminator model (FIG. 5) estimates the probability that a sample came from the training data rather than from the generative model.

The computing device 12 may include, as explained herein, a personal computer, remote server, tablet PC, mobile computing device, or the like, although other computing devices may be used (e.g., devices that incorporate one or more graphic processing units (GPUs) or application specific integrated circuits (ASICs)). The image processing software 16 can be implemented in any number of software packages and platforms (e.g., Python, TensorFlow, MATLAB, C++, and the like). Network training of the GAN-based deep neural network 18 may be performed the same or different computing device 12. For example, in one embodiment a personal computer (PC) 12 may be used to train the deep neural network 18 although such training may take a considerable amount of time. To accelerate this training process, a computing device 12 using one or more dedicated GPUs may be used for training. Once the deep neural network 18 is trained, the deep neural network 18 may be executed using the same or different computing device 12. For example, training may take place on a remotely located computing device 12 with the trained deep neural network 18 (or parameters thereof) being transferred to another computing device 12 for execution. Transfer may take place across a wide area network (WAN) such as the Internet or a local area network (LAN).

The computing device 12 may optionally include one or more input devices 20 such as the keyboard and mouse as illustrated in FIG. 1A. For example, input device(s) 20 may be used to interact with the image processing software 16. For example, the user may be provided with a graphical user interface (GUI) which he or she may interact with the color output image 100. The GUI may provide the user with a series of tools or a toolbar that can be used to manipulate various aspects of the color output image 100 of the sample 4. This includes the ability to adjust colors, contrast, saturation, magnification, image cutting and copying and the like. The GUI may allow for rapid selection and viewing of color images 100 of the sample 4. The GUI may identify sample type, stain or dye type, sample ID, and the like.

In one embodiment, the system further includes a microscope device 22 that is used to acquire images of the sample 4 that are used by the deep neural network 18 to reconstruct the color output image 100. The microscope device 22 includes a plurality of light sources 24 that are used to illuminate the sample 4 with coherent or partially coherent light. The plurality of light sources 24 may include LEDs, laser diodes, and the like. As explained herein, in one embodiment, at least one of the light sources 24 emits red colored light, while at least one of the light sources 24 emits green colored light, and while at least one of the light sources 24 emits blue colored light. As explained herein, the light sources 24 are powered simultaneously to illuminate the sample 4 using appropriate driver circuitry or controller. The light sources 24 may be connected to fiber optic cable(s), fiber(s), waveguide(s) 26 or the like as is illustrated in FIG. 1A which is used to emit light onto the sample 4. The sample 4 is supported on a sample holder 28 which may include an optically transparent substrate or the like (e.g., glass, polymer, plastic). The sample 4 is typically illuminated from the fiber optic cable(s), fiber(s), waveguide(s) 26 that is typically located several centimeters away from the sample 4.

The sample 4 that may be imaged using the microscope device 22 may include any number of types of samples 4, The sample 4 may include a section of mammalian or plant tissue that has been chemically stained or labelled (e.g., chemically stained cytology slides). The sample may be fixed or non-fixed. Exemplary stains include, for example, Hematoxylin and Eosin (H&E) stain, haematoxylin, eosin, Jones silver stain, Masson's Trichrome Periodic acid-Schiff (PAS) stains, Congo Red stain, Alcian Blue stain, Blue Iron, Silver nitrate, trichrome stains, Ziehl Neelsen, Grocott's Methenamine Silver (GMS) stains, Gram Stains, acidic stains, basic stains, Silver stains, Nissl, Weigert's stains, Golgi stain, Luxol fast blue stain, Toluidine Blue, Genta, Mallory's Trichrome stain, Gomori Trichrome, van Gieson, Giemsa, Sudan Black, Perls' Prussian, Best's Carmine, Acridine Orange, immunofluorescent stains, immunohistochemical stains, Kinyoun's-cold stain, Albert's staining, Flagellar staining, Endospore staining, Nigrosin, or India Ink, The sample 4 may also include non-tissue samples. These include small objects which may be inorganic or organic. This may include particles, dusts, pollen, molds, spores, fibers, hairs, mites, allergens and the like. Small organisms may also be imaged in color. This includes bacteria, yeast, protozoa, plankton, and multi-cellular organism(s). In addition, in some embodiments, the sample 4 does not need to be stained or labelled as the natural or native color of the sample 4 may be used for color imaging.

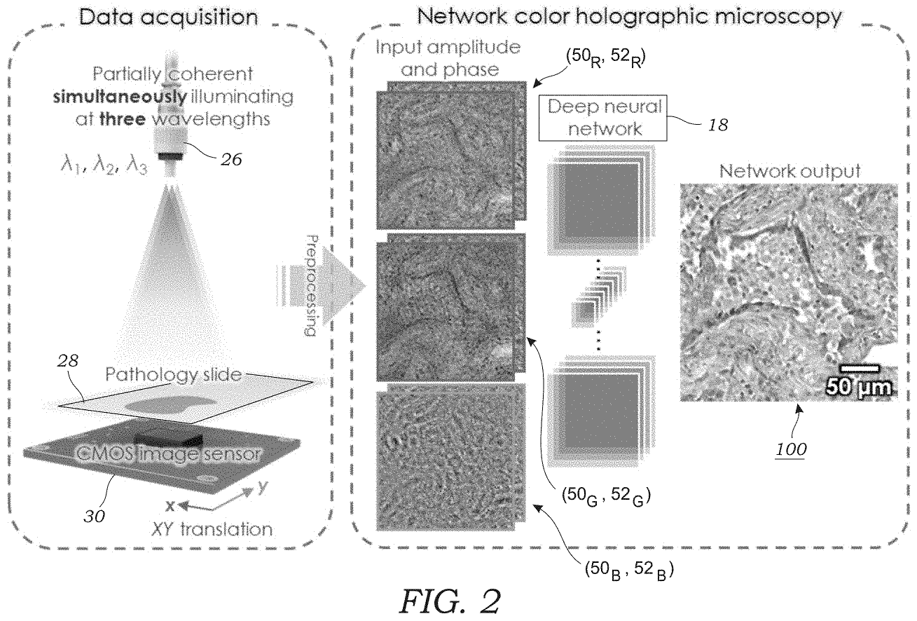

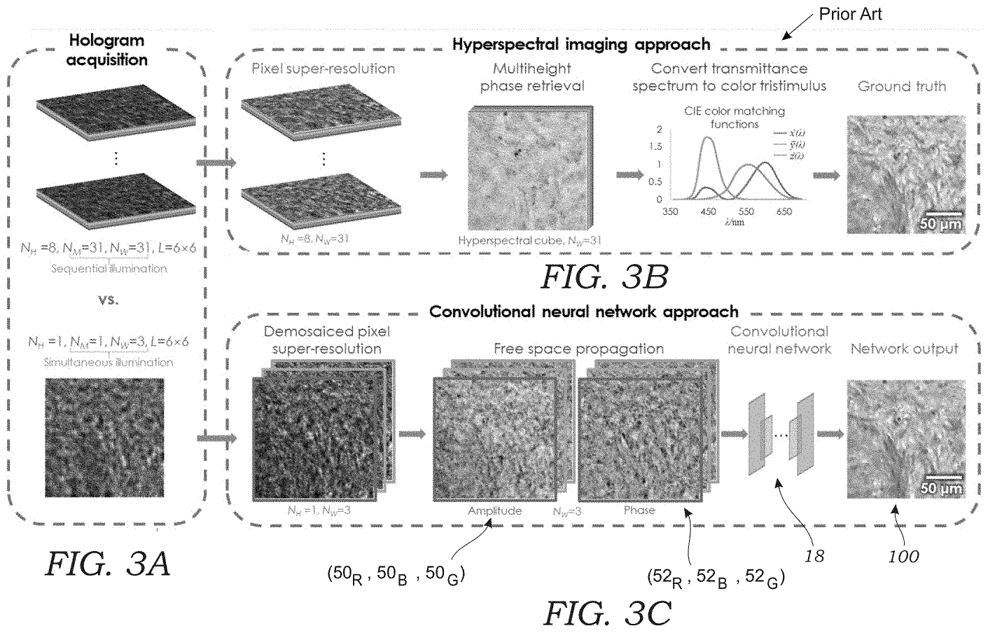

Still referring to FIG. 1A, the microscope device 22 obtains a plurality of low-resolution, sub-pixel shifted images with simultaneous illumination at different wavelengths (three are used in the experiments described herein). As seen in FIGS. 1A and 2, three different wavelengths (λ₁, λ₂, λ₃) simultaneously illuminate the sample 4 (e.g., pathology slide with pathological sample disposed thereon) and images are captured with a color image sensor 30. The image sensor 30 may include a CMOS-based color image sensor 30. The color image sensor 30 is located on the opposing side of the sample 4 as the fiber optic cable(s), fiber(s), waveguide(s) 26. The image sensor 30 is typically located adjacent or very near to the sample holder 28 and at a smaller distance than distance between the sample 4 and the fiber optic cable(s), fiber(s), waveguide(s) 26 (e.g., less than a cm and may be several mm or less).

A translation stage 32 is provided that imparts relative movement in the x and y planes (FIG. 1A and FIG. 2) between the sample holder 28 and the image sensor 30 to obtain the sub-pixel shifted images. The translation stage 32 may move either the image sensor 30 or the sample holder 28 in the x and y directions. Of course, both the image sensor 30 and the sample 28 may be moved but this may require a more complicated translation stage 32. In a separate alternative, the fiber optic cable(s), fiber(s), waveguide(s) 26 may be moved in the x, y planes to generated the sub-pixel shifts. The translation stage 32 moves in small jogs (e.g., smaller than 1 μm typically) to obtain an array of images 34 obtained at different x, y locations with a single low-resolution hologram obtained at each position. For example, a 6×6 grid of positions may be used to acquire thirty-six (36) total low-resolution images 34. While any number of low-resolution images 34 may be obtained this may typically be less than 40.

These low-resolution images 34 are then used to digitally create a super-resolved hologram for each of the three color channels using demosaiced pixel super-resolution. A shift-and-add process or algorithm is used to synthesize the high-resolution image. The shift-and-add process used to synthesize a pixel super-resolution hologram is described in, for example, Greenbaum, A. et al., Wide-field computational imaging of pathology slides using lens-free on-chip microscopy, Science Translational Medicine 6, 267ra175-267ra175 (2014), which is incorporated herein by reference. In this process, accurate estimates of the shifts for the precise synthesis of the high-resolution holograms is made without the need for any feedback or measurement from the translation stage 32 or setup using an iterative gradient based technique.

The three intensity color hologram channels (red, blue, green) of this super-resolved hologram are then digitally backpropagated to an object plane to generate six inputs for the trained deep neural network 18 (FIG. 2). This includes three (3) amplitude image channels (50_{R}, 50_{B}, 50_{G}) and three (3) phase image channels (52_{R}, 52_{B}, 52_{C}) which are input to the trained deep neural network 18 generate the reconstructed color output image 40. The pixel-super resolution algorithm may be executed using the same image processing software 16 or different image processing software from that used to execute the trained deep neural network 18. The color output image 100 is a high-fidelity image that compares with that obtained using multiple super-resolved holograms collected as multiple sample-to-sensor distances (z) (i.e., the hyperspectral imaging approach). The system 2 and method are less data intensive and improves the overall time performance or throughput as compared to the “gold standard” approach of hyperspectral imaging,

FIG. 1B illustrates an alternative embodiment of the system 2 that uses an array of light sources 40. In this alternative embodiment, an array of light sources 40 having different colors is arrayed across the x, y plane of the sample 4 and sample holder 28. In this alternative embodiment, there is no need for the translation stage 32 as the sub-pixel “movement” is accomplished by illuminating the sample 4 with a different set of light sources from the array 40 that is located at different spatial locations above the sample 4. This creates the same effect of having to move either the image sensor 30 or the sample holder 28. Different sets of red, blue, and green light sources in the array 40 are selectively illuminated to generate the sub-pixel shifts used to synthesize the pixel super-resolution hologram. The array 40 may be formed from a bundle of optical fibers that are coupled at one end to light sources (e.g., LEDs) and the opposing end is contained in a header or manifold that secures the opposing end of the optical fibers in the desired array pattern.

FIG. 1C illustrates a process or method that is used to perform color image reconstruction of a single super-resolved holographic image of a sample 4. With reference to operation 200, the microscope device 22 obtains a plurality of sub-pixel shifted lower resolution hologram intensity images of the sample 4 using a color image sensor 30 by simultaneous illumination of the sample 4 at a plurality of color channels (e.g., red, blue, green). Next, in operation 210, super-resolved hologram intensity images for each of the plurality of color channels are digitally generated (three such super-resolved. holograms including one for the red channel, one for the green channel, and one for the blue channel) based on the plurality of sub-pixel shifted lower resolution hologram intensity images. Next, in operation 220, the super-resolved hologram intensity images for each of the plurality of color channels are then back-propagated to an object plane within the sample 4 with image processing software 16 to generate an amplitude input image and a phase input image of the sample for each of the plurality of color channels which results in six (6) total images. The trained deep neural network 18, which is executed by the image processing software 16 using one or more processors 14 of the computing device 12, receives (operation 230) the amplitude input image and the phase input image of the sample 4 for each of the plurality of color channels (e.g., the six input images) and outputs (operation 240) a color output image 100 of the sample 4. The color output image 40 is a high-fidelity image that compares with that obtained using multiple super-resolved holograms collected as multiple sample-to-sensor distances (i.e., hyperspectral imaging approach). This color output image 100 may include a color amplitude image 100 of the sample 4.

The system 2 and method are less data intensive and improves the overall time performance or throughput as compared to the “gold standard” approach of hyperspectral imaging. The system 2 does not need to obtain multiple (i.e., four) super-resolved holograms collected at four different heights or sample-to-image sensor distances. This means that the color output image 100 may be obtained quicker (and higher throughput). The use of a single super-resolved hologram also means that the imaging process is less data intensive; requiring less storage and data processing resources.

Experimental

Materials and Methods

Overview of the Hyperspectral and Deep Neural Network-Based Reconstruction Approaches

The deep neural network 18 was trained to perform the image transformation from a complex field obtained from a single super-resolved hologram to the gold-standard image (obtained with the hyperspectral imaging approach), which is obtained from N_{H}×N_{M} super-resolved holograms (N_{H} is the number of sample-to-sensor distances, and N_{M} is the number of measurements at one specific illumination condition). To generate the gold-standard images using the hyperspectral imaging approach. N_{H}=8 and N_{M}=31 sequential illumination wavelengths (ranging from 400 nm to 700 nm with 10 nm step size) were used. The following detail the procedures used to generate both the gold-standard images as well as the inputs to the deep network.

Hyperspectral Imaging Approach

The gold-standard, hyperspectral imaging approach reconstructs a high-fidelity color image by first performing resolution enhancement using a PSR algorithm (Discussed in more detail in Holographic pixel super-resolution using sequential illumination below) Subsequently, the missing phase-related artifacts are eliminated using multi-height phase recovery (Discussed in more detail in Multi-height phase recovery below). Finally, high-fidelity color images are generated with tristimulus color projections (Discussed in more detail in Color tristimulus projection below).

Holographic Pixel Super-Resolution Using Sequential Illumination

The resolution enhancement for the hyperspectral imaging approach was performed using a PSR algorithm as described in Greenbaum, A. et al., Wide-field computational imaging of pathology slides using lens-free on-chip microscopy, Science Translational Medicine 6, 267ra175-267ra175 (2014), which is incorporated herein by reference. This algorithm is capable of digitally synthesizing a high-resolution image (pixel size of approximately 0.37 μm) from a set of low-resolution images 34 collected by an RGB image sensor 30 (IMX 081, Sony, pixel size of 1.12 μm, with R, G₁, G₂, and B color channels). To acquire these images 34, the image sensor 30 was programmed to raster through a 6×6 lateral grid using a 3D positioning stage 32 (MAX606, Thorlabs, Inc.) with a. subpixel spacing of ˜0.37 μm (i.e., ⅓ of the pixel size). At each lateral position, one low-resolution hologram intensity was recorded. The displacement/shift of the image sensor 30 was accurately estimated using the algorithm introduced in Greenbaum et al., Field-portable wide-field microscopy of dense samples using multi-height pixel super-resolution based lensfree imaging, Lab Chip 12, 1242-1245 (2012), which is incorporated by reference herein. A shift-and-add based algorithm was then used to synthesize the high-resolution image as outlined in Greenbaum et al. (2014), supra.

Because this hyperspectral imaging approach uses sequential illumination, the PSR algorithm uses only one color channel (R, G₁, or B) from the RGB image sensor at any given illumination wavelength. Based on the transmission spectral response curves of the Bayer RGB image sensor, the blue channel (B) was used for the illumination wavelengths in the range of 400-470 nm. the green channel (GI) was used for the illumination wavelengths in the range of 480-580 nm, and the red channel (R) was used for the illumination wavelengths in the range of 590-700 nm.

Angular Spectrum Propagation

Free-space angular spectrum propagation was used in the hyperspectral imaging approach to create the ground truth images. To digitally obtain the optical field U(x,y; z) at a propagation distance z, the Fourier transform (FT) is first applied to the given U(x,y; 0) to obtain the angular spectrum distribution A(fₓ, f_{y}; 0). The angular spectrum A(fₓ, f_{y}; z) of the optical field U(x,y; z) can be calculated using:

A(fₓf_{y};z)=A(fₓ,f_{y};0)·H(fₓ,f_{y};z) (1)

where H(fₓ, f_{y}; z) is defined as,

$$H ( {f}_{x} , {f}_{y} ; z ) = \{ \begin{matrix}0 , {( \frac{λ {f}_{x}}{n} )}^{2} + {( \frac{λ {f}_{y}}{n} )}^{2} > 1 \\ exp [ j 2 π \frac{n}{λ} z \sqrt{1 - {( \frac{λ {f}_{x}}{n} )}^{2} - {( \frac{λ {f}_{y}}{n} )}^{2}} ] , otherwise\end{matrix} \qquad ( 2 )$$

where λ is the illumination wavelength, and n is the refractive index of the medium. Finally, an inverse Fourier transform is applied to A(fₓ,f_{y}; z) to get U(x,y; z).

This angular spectrum propagation method first served as the building block of an autofocusing algorithm, which is used to estimate the sample to sensor distance for each acquired hologram as outlined in Zhang et al., Edge sparsity criterion for robust holographic autofocusing, Optics Letters 42, 3824 (2017) and Tamamitsu et al., Comparison of Gini index and Tamura coefficient for holographic autofocusing based on the edge sparsity of the complex optical wavefront, arXiv:1708.08055 [physics.optics] (2017), which are incorporated by reference herein. After the accurate sample-to-sensor distances were estimated, the hyperspectral imaging approach used the angular spectrum propagation as an additional building block for the iterative multi-height phase recovery.

Multi-Height Phase Recovery

To eliminate the spatial image artifacts related to the missing phase, the hyperspectral imaging approach applied an iterative phase retrieval algorithm. An iterative phase retrieval method is used to recover this missing phase information details of which may be found in Greenhawn et al., Maskless imaging of dense samples using pixel super-resolution based multi-height lensfree on-chip microscopy, Opt. Express, OE 20, 3129-3143 (2012), which is incorporated herein by reference,

Holograms from eight sample-to-sensor distances were collected during the data acquisition step. The algorithm initially assigned a zero-phase to the intensity measurement of the object. Each iteration of the algorithm began by propagating the complex field from the first height to the eighth height, and by backpropagating it to the first height. The amplitude was updated at each height, while the phase was kept unchanged. The algorithm typically converged after 10-30 iterations. Finally, the complex field was backpropagated from any one of the measurement planes to the object plane to retrieve both the amplitude and the phase images.

Color Tristimulus Projection

Increased color accuracy was achieved by densely sampling the visible band at thirty-one (31) different wavelengths in the range of 400 nm to 700 nm at a 10 nm step size. This spectral information was projected. to a color tristimulus using the Commission Internationale de l'Eclairage (CIE) color matching function. The color tristimulus in the XYZ color space can be calculated by,

X=∫x̅(λ)T(λ)E(λ)dλ

Y=∫y̅(λ)T(λ)E(λ)dλ

Z=∫z̅(λ)T(λ)E(λ)dλ (3)

where T(λ) is the wavelength, x̅(λ, y̅(λ), and z̅(λ) are the CIE color matching functions, T(λ) is the transmittance spectrum of the sample, and E(λ) is the CIE standard illuminant D65. The XYZ values can be linearly transformed to the standard RGB values for display.

High-Fidelity Holographic Color Reconstruction Via Deep Neural Networks

The input complex fields for the deep learning-based color reconstruction framework were generated in the following manner: Resolution enhancement and cross-talk correction through the demosaiced pixel super resolution algorithm (Holographic pixel super-resolution using sequential illumination description) followed by the initial estimation of the object via the angular spectrum propagation (Angular spectrum propagation description).

Holographic Demosaiced Pixel Super-Resolution (DPSR) Using Multiplexed Illumination

Similar to the hyperspectral imaging approach, the trained deep neural network approach also used a shift-and-add-based algorithm in association with 6×6 low-resolution holograms to enhance the hologram resolution. Three multiplexed wavelengths were used, i.e., simultaneously illuminated the sample 4 with three distinct wavelengths. To correct the cross-talk error among different color channels in the RGB sensor the DPSR algorithm was used as outlined in Wu et al., Demosaiced pixel super-resolution for multiplexed holographic color imaging, Sci Rep 6, (2016), which is incorporated herein by reference. This cross-talk correction can be illustrated by the following equation:

$$[ \begin{matrix}{U}_{R} \\ {U}_{G} \\ {U}_{B}\end{matrix} ] = W \times [ \begin{matrix}{U}_{R \_ ori} \\ {U}_{{G}_{1} \_ ori} \\ {U}_{{G}_{2} \_ ori} \\ {U}_{B \_ ori}\end{matrix} ] \qquad ( 4 )$$

where U_{R-ori}, U_{G}_{₁}₋ₒᵣᵢ, U_{G}_{₂}ₒᵣᵢ, and U_{B-ori}, represent the original interference patterns collected by the image sensor, W is a 3×4 cross-talk matrix obtained by experimental calibration of a given RGB image sensor 30, and U_{R}, U_{G}, and U_{B}, are the demultiplexed (R, B) interference patterns. Here, the three illumination wavelengths were chosen to be at 450 nm, 540 nm, and 590 nm. Using these wavelengths, a better color accuracy can be achieved with specific tissue-stain types (i.e., prostate stained with H&E and lung stained with Masson's trichrome, which were used in this work). Of course, it should be appreciated that other stain or dye types may use different illumination wavelengths.

Deep Neural Network Input Formation

Following the demosaiced pixel-super-resolution algorithm, the three intensity holograms are numerically backpropagated to the object plane, as discussed in the “Angular spectrum propagation” section herein. Following this back-propagation step, each one of the three color hologram channels will produce a complex wave, represented as real and imaginary data channels (50_{R}, 50_{B}, 50_{G}, 52_{R}, 52_{B}, 52_{G}). This results in a six-channel tensor that is used as input to the deep network, as shown in FIG. 2. Unlike the ground truth, in this case, no phase retrieval is performed because only a single measurement is available.

Deep Neural Network Architecture

The deep neural network 18 was a generative adversarial network (GAN) that was implemented to learn the color correction and eliminate the missing phase-related artifacts. This GAN framework has recently found applications in super-resolution microscopic imaging and histopathology, and it consists of a discriminator network (I)) and a generator network (G) (FIGS. 4 and 5). The D network (FIG. 5) was used to distinguish between a three-channel RGB ground truth image (z) obtained from hyperspectral imaging and the output image from G. Accordingly, G (FIG. 4) was used to learn the transformation from a six-channel holographic image (x), i.e., three color channels with real and imaginary components, into the corresponding RGB ground truth image.

The discriminator and generator losses are defined as,

$$\begin{matrix}{l}_{discriminator} = {D ( G ( x ) )}^{2} + {( 1 - D ( z ) )}^{2} & ( 5 ) \\ {l}_{generator} = {L}_{2} \{ z , G ( x ) \} + λ \times TV \{ G ( x ) \} + α \times {( 1 - D ( G ( x ) ) )}^{2} & ( 6 ) \\ where , & \\ {L}_{2} \{ z , G ( x ) \} = \frac{1}{{N}_{channels} \times M \times N} {\sum }_{n = 1}^{{N}_{channels}} {\sum }_{i , j = 1}^{M , N} {( {x}_{i , j , n} - {z}_{i , j , n} )}^{2} & ( 7 )\end{matrix}$$

where N_{channels} is the number of channels in the images (e.g., N_{channels}=3 for an RGB image). M and N are the number of pixels for each side of the images, i and j are the pixel indices, and n denotes the channel indices. TV represents the total variation regularizer that applies to the generator output, and is defined as,

$$T V ( x ) = \frac{1}{{N}_{channels}} {\sum }_{n = 1}^{{N}_{channels}} {\sum }_{i , j = 1}^{M , N} ( \vert {x}_{i + 1 , j , n} - {x}_{i , j , n} \vert + \vert {x}_{i , j + 1 , n} - {x}_{i , j , n} \vert ) \qquad ( 8 )$$

The regularization parameters (λ, α) were set to 0.0025 and 0.002 so that the total variation loss (λ×TV{G(xᵢₙₚᵤₜ)}) is ˜2% of L₂, and the discriminator loss (α×(1−D(G(xᵢₙₚᵤₜ)))²) is ˜15% of I_{generator}. Ideally, both D(z_{label}) and D(G(xᵢₙₚᵤₜ)) converge to 0.5 at the end of the training phase.

The generator network architecture (FIG. 4) was an adapted form of the U-net. Additionally, the discriminator network (FIG. 5) used a simple classifier that consisted of a series of convolutional layers which slowly reduced the dimensionality, while they increased the number of channels, followed by two fully connected layers to output the classification. The U-net is ideal for cleaning missing phase artifacts and for performing color correction on the reconstructed images. The convolution filter size was set to 3×3, and each convolutional layer except the last was followed by a leaky-ReLu activation function, defined as:

$$leaky - ReL u ( x ) = \{ \begin{matrix}x & for x > 0 \\ 0.1 x & otherwise\end{matrix} \qquad ( 9 )$$

Deep Neural Network Training Process
In the network training process, the images generated by the hyperspectral approach were used as the network labels, and the demosaiced super-resolved holograms that were back-propagated to the sample plane were used as the network inputs. Both the generator and the discriminator networks were trained with a patch size of 128×128 pixels. The weights in the convolutional layers and fully connected layers, were initialized using the Xavier initialization while the biases were initialized to zero. All parameters were updated using an adaptive moment estimation (Adam) optimizer with a learning rate of 1×10⁻⁴ for the generator network and a corresponding rate of 5×10⁻⁵ for the discriminator network. The training, validation, and testing of the network were performed on a PC with a four-core 3.60 GHz CPU, 16 GB of RAM, and a Nvidia GeForce GTX 1080Ti GPU.

Bright-Field Imaging

For comparison of the imaging throughput, bright-field microscopy images were obtained. An Olympus IX83 microscope equipped with a motorized stage and a set of super panchromatic objectives (Olympus UPLSAPO 20×/0.75 numerical aperture (NA), working distance (WD) 0.65) were used. The microscope was controlled by the MetaMorph advanced digital imaging software (Version 7.10.1.161, MetaMorph®) with the autofocusing algorithm set to search in a range of 5 μm in the z-direction with 1 μm accuracy. Two-pixel binning was enabled and a 10% overlap between the scanned patches was used.

Quantification Metrics

Quantification metrics were chosen and used to evaluate the performance of the network: the SSIM was used to compare the similarity of the tissue structural information between the output and the target images; ΔE*94 was used to compare the color distance of the two images.

SSIM values ranged from zero to one, whereby the value of unity indicated that the two images were the same, i.e.,

$$SSIM ( U , V ) = \frac{( 2 {μ}_{U} {μ}_{V} + {C}_{1} ) ( 2 {σ}_{U , V} + {C}_{2} )}{( {μ}_{V}^{2} + {μ}_{V}^{2} + {C}_{1} ) ( {σ}_{U}^{2} + {σ}_{V}^{2} + {C}_{2} )} \qquad ( 10 )$$

where U and V represent one vectorized test image and one vectorized reference image respectively, μ_{U} and μ_{V} are the means of U and V, respectively, σ_{U}², σ_{V}² are the variances of U and V, respectively, σ_{U,V} is the covariance of U and V, and constants C₁ and C₂ are included to stabilize the division when the denominator is close to zero.

The second metric that was used, ΔE*94, outputs a number between zero and 100. A value of zero indicates that the compared pixels share the exact same color, while a value of 100 indicates that the two images have the opposite color (mixing two opposite colors cancel each other out and produce a grayscale color). This method calculates the color distance in a pixel-wise fashion, and the final result is calculated by averaging the values of ΔE*94 in every pixel of the output image.

Sample Preparation

De-identified H&E stained human prostate tissue slides and Masson's trichrome stained human lung tissue slides were acquired from the UCLA Translational Pathology Core Laboratory. Existing and anonymous specimens were used. No subject related information was linked or can he retrieved.

Results and Discussion

Qualitative Assessment

The performance of the trained deep neural network 18 was evaluated using two different tissue-stain combinations: prostate tissue sections stained with H&E, and lung tissue sections stained with Masson's trichrome, For both types of samples, the deep neural networks 18 were trained on three tissue sections from different patients and were blindly tested on another tissue section from a fourth patient. The field-of-view (FOV) of each tissue section that was used for training and testing was ˜20 mm².

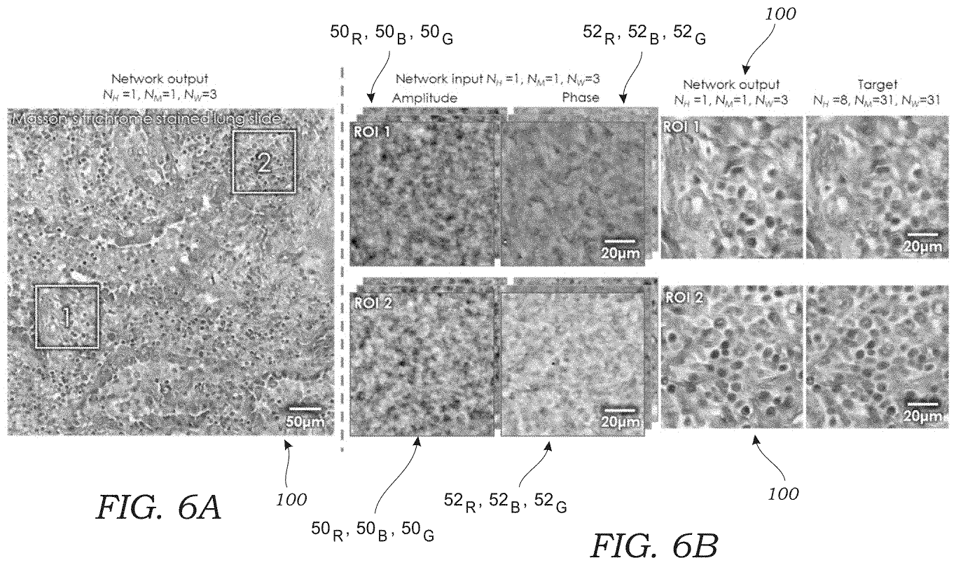

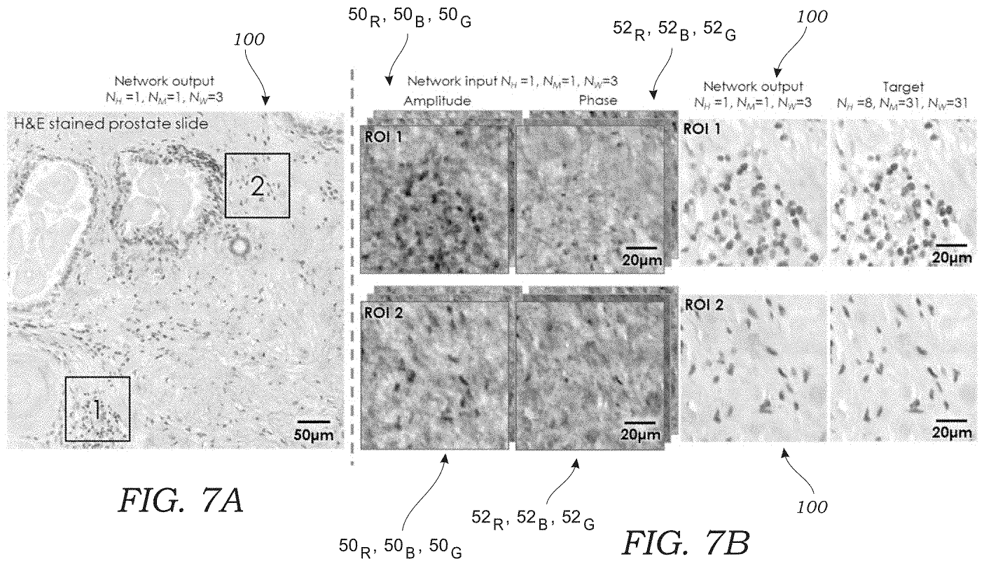

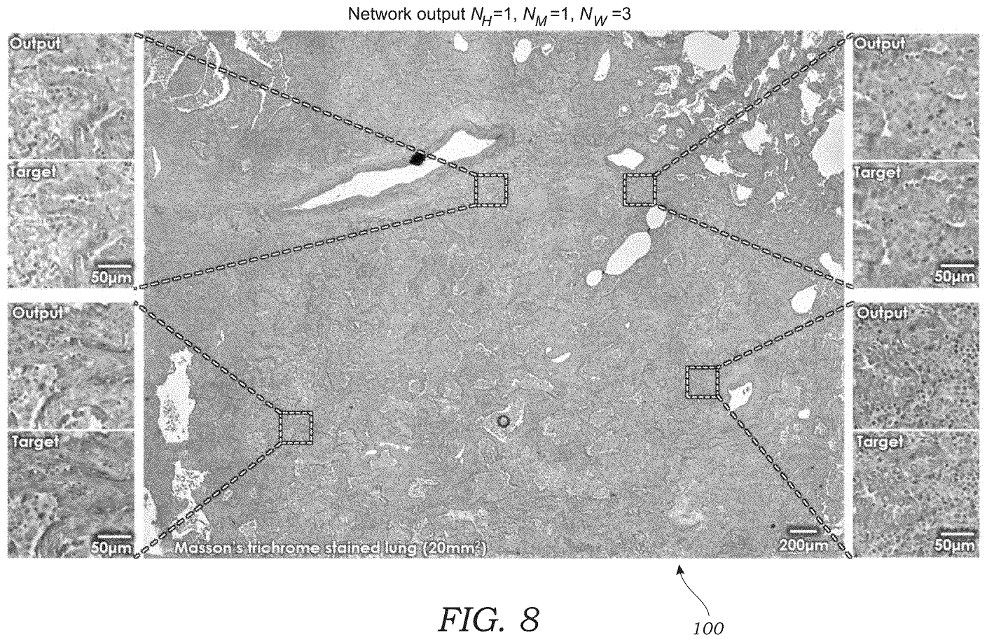

The results for lung and prostate samples are respectively summarized in FIGS. 6A-6B, 7A, and 7B. These performance of the color output of the trained deep neural network 18 demonstrate the capability of reconstructing a high-fidelity and color-accurate image from a single non-phase-retrieved and wavelength-multiplexed hologram. Using the trained deep neural network 18, the system 2 was able to reconstruct the image of the sample 4 over the entire sensor's FOV (i.e., ˜20 mm²), as demonstrated in FIG. 8.

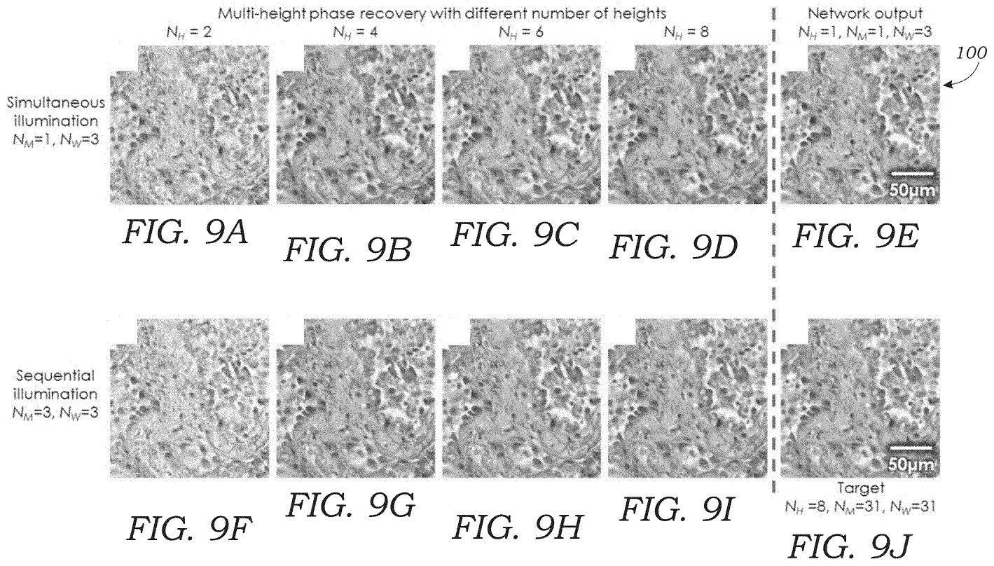

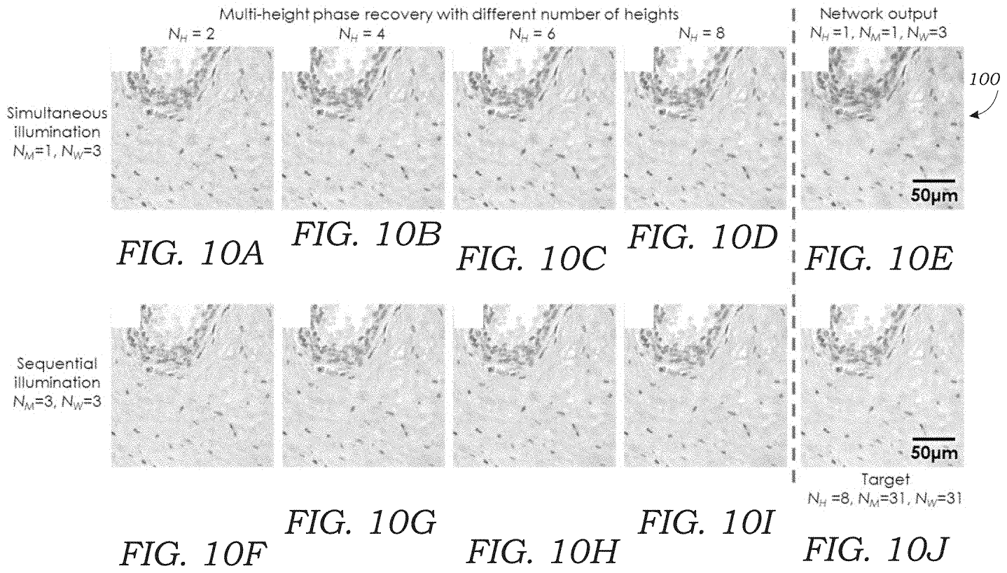

To further demonstrate the qualitative performance of the deep neural network 18, FIGS. 9A-9J and 10A-10J show the reconstruction results of the deep neural network 18 (FIGS. 9I and 10I) to the images created by the absorbance spectrum estimation method in terms of the required number of measurements. For this comparison, the spectrum estimation approach was used for the multi-height phase recovery method and reconstructed the color images from a reduced number of wavelengths via both sequential (N_{H}=8, N_{M}=3) and multiplexed (N_{H}=8, N_{M}=1) illuminations at the same wavelengths (i.e., 450 nm, 540 nm, and 590 nm) (FIGS. 9A-9H and 10A-10H). Qualitatively, the deep neural network 18 results are comparable to the multi-height results obtained with more than four sample-to-sensor distances for both the sequential and multiplexed illumination cases. This is also confirmed by the quantitative analysis described below.

Quantitative Performance Assessment

The quantitative performance of the network was evaluated based on the calculation of the SSIM and color difference (ΔE*94) between the output of the deep neural network 18 and the gold-standard image produced by the hyperspectral imaging approach. As listed in Table 1, the performances of the spectrum estimation methods decrease (i.e., SSIM decreases and ΔE*94 increases as the number of holograms at different sample-to-sensor distances decreases, or when the illumination is changed to be multiplexed. This quantitative comparison demonstrates that the performance of the deep neural network 18 using a single super-resolved hologram is comparable to the results obtained by state-of-the-art algorithms where times as many raw holographic measurements are used.

TABLE 1

| | | Illumination | | | |
|---|---|---|---|---|---|
| | | condition (at | | | |
| | | 450 nm, 540 | Total required | | |
| Tissue-stain | | nm, and 590 | measurments | Average | |
| type | Method | nm) | (Nₙ × N_{M} × L) | SSIM | ΔE*94 |
| Masson's | Deep neural | Simultaneous | 1 × 1 × 36 | 0.8396 | 6.9044 |
| trichrome | network | | | | |
| stained lung | Two-height | Simultaneous | 2 × 1 × 36 | 0.5535 | 10.7507 |
| slide | reconstruction | Sequential | 2 × 3 × 36 | 0.6011 | 9.4786 |
| (~20 mm² FOV) | Four-height | Simultaneous | 4 × 1 × 36 | 0.8344 | 5.1674 |
| | reconstruction | Sequential | 4 × 3 × 36 | 0.8769 | 3.8709 |
| | Six-height | Simultaneous | 6 × 1 × 36 | 0.878 | 4.4219 |
| | reconstruction | sequential | 6 × 1 × 36 | 0.9136 | 3.1928 |
| | Eight-height | Simultaneous | 8 × 1 × 36 | 0.9068 | 3.6779 |
| | reconstruction | Sequential | 8 × 3 × 36 | 0.9538 | 2.1849 |
| Hematoxylin | Deep neural | Simultaneous | 1 × 1 × 36 | 0.9249 | 4.5228 |
| and Eosin | network | | | | |
| stained prostate | Two-height | Simultaneous | 2 × 1 × 36 | 0.7716 | 7.5085 |
| slide | reconstruction | Sequential | 2 × 3 × 36 | 0.848 | 5.5316 |
| (~20 mm² FOV) | Four-height | Simultaneous | 4 × 1 × 36 | 0.8984 | 4.3878 |
| | reconstruction | sequential | 4 × 3 × 36 | 0.9335 | 3.1199 |
| | Six-height | Simultaneous | 6 × 1 × 36 | 0.9225 | 3.8911 |
| | reconstruction | Sequential | 6 × 3 × 36 | 0.9516 | 2.9622 |
| | Eight-height | Simultaneous | 8 × 1 × 36 | 0.9411 | 3.5102 |
| | reconstruction | Sequential | 8 × 3 × 36 | 0.9689 | 2.4148 |

Comparison of SSIM and ΔE*94 performances between that of the deep neural network 18 and various other methods using two, four, six, and eight sample-to-sensor heights and three sequential/multiplexed wavelength illumination conditions for two tissue samples (the network-based approach and other methods with comparable performance are highlighted with bold font).

Throughput Evaluation

Table 2 lists the measured reconstruction times for the entire FOV (˜20 mm²) using different methods. For the deep neural network 18, the total reconstruction time includes the acquisition of 36 holograms (at 6×6 lateral positions in multiplexed illumination), the execution of DPSR, angular spectrum propagation, network inference, and image stitching. For the hyperspectral imaging approach, the total reconstruction time includes the collection of 8925 holograms (at 6×6 lateral positions, eight sample-to-sensor distances, and 31 wavelengths), PSR, multi-height phase retrieval, color tristimulus projection, and image stitching. For the conventional bright-field microscope (equipped with an automatic scanning stage), the total time includes the scanning of the bright-field images using a 20×/0.75 NA microscope with autofocusing performed at each scanning position and image stitching. In addition, the timing of the multi-height phase recovery method with the use of four sample-to-sensor distances was also shown, and had the closest performance to the deep learning-based neural network approach. All the coherent imaging related algorithms were accelerated with a Nvidia GTX 1080Ti GPU and CUDA C++ programming.

TABLE 2

| | | | | Processing time | | | | | | | | | | | | Storage | |
|---|---|---|---|---|---|---|---|---|---|---|---|---|---|---|---|---|---|
| | | Data | | | | | | Phase | | Inference or | | | | | | space | |
| Testing | | acquisition | | Auto- | | Super | | recovery | | color | | | | Total | | (raw | |
| area | Method | time | | Focusing | | resolution | | or FSP | | transformation | | Stitching | | time | | data) | |
| Entire | Deep neural | ~2 | min | ~20 | s | ~2 | min | ~3 | s | ~1.5 | min | ~1 | min | ~7 | min | 1.09 | GB |
| FOV of | network | | | | | | | | | | | | | | | | |
| sensor | Four-height | ~8 | min | ~80 | s | ~9 | min | ~5 | min | ~36 | min | ~1 | min | ~60 | min | 4.36 | GB |
| ~20 | simultaneous | | | | | | | | | | | | | | | | |
| mm² | Four-height | ~25 | min | ~80 | s | ~9 | min | ~5 | min | ~36 | min | ~1 | min | ~77 | min | 1.3.08 | GB |
| | sequential | | | | | | | | | | | | | | | | |
| | Hyperspectral | ~8 | h | ~27 | min | ~3 | h | ~85 | min | ~15 | min | ~1 | min | ~13 | h | 270.32 | GB |
| | imaging | | | | | | | | | | | | | | | | |

| | | | | | | | | | | | | |
|---|---|---|---|---|---|---|---|---|---|---|---|---|
| Conventional | ~6 | min | N/A | N/A | N/A | N/A | ~1 | min | ~7 | min | 577.13 | MB |
| microscope | | | | | | | | | | | | |
| (20×/0.75 NA) | | | | | | | | | | | | |

Table 2. Time performance evaluation of the deep neural network approach for reconstructing accurate color images compared to traditional hyperspectral imaging approach and standard brightfield microscopic sample scanning (where N/A stands for “not applicable”).

The deep neural network-based method took ˜7 min to acquire and reconstruct a 20 mm² tissue area, which was approximately equal to the time it would take to image the same region using the 20× objective with a standard, general-purpose, bright-field scanning microscope. In general, the method enables the reconstruction of a FOV of at least 10 mm² in under 10 minutes. Of course, increasing processing power and the type of sample 4 may impact reconstruction timing but this is typically done in several minutes. Note that this is significantly shorter than the ˜60 min required when using the spectral estimation approach (with four heights and simultaneous illumination). The system 2 and deep learning-based method also increases the data efficiency. The raw super-resolved hologram data size was reduced from 4.36 GB to 1.09 GB, which is more comparable to the data size of bright-field scanning microscopy images, which in total used 577.13 MB.

The system 2 was used to generate a reconstructed color output image 100 of a sample 4 that included histologically stained pathology slides. The system 2 and method described herein significantly simplifies the data acquisition procedure, reduced the data storage requirement, shortened the processing time, and enhanced the color accuracy of the holographically reconstructed images. It is important to note that other technologies, such as slide-scanner microscopes used in pathology can readily scan tissue slides at much faster rates, although they are rather expensive for use in resource limited settings. Therefore, alternatives to the lens-less holographic imaging hardware, such as for example, the use of illumination arrays 40 to perform pixel super resolution may improve the overall reconstruction time.

While embodiments of the present invention have been shown and described, various modifications may be made without departing from the scope of the present invention. For example, while the invention has been described largely as using a lensfree microscope device, the methods described herein may also be used with lens-based microscope devices. For example, the input images to be reconstructed may include images obtained from a coherent lens-based computational microscope such as a Fourier Ptychographic microscope. In addition, while hyperspectral imaging was used to generate the gold standard or target color images for network training, other imaging modalities can be used for training. This includes not only computational microscopes (e.g., corresponding ground truth or target color images are numerically simulated or computed) but also brightfield microscopy images. The invention, therefore, should not be limited except to the following claims and their equivalents.

1. A method of performing color image reconstruction of a single super-resolved holographic image of a sample comprising:
obtaining a plurality of sub-pixel shifted lower resolution hologram intensity images of the sample using an image sensor by simultaneous illumination of the sample at a plurality of color channels;
digitally generating super-resolved hologram intensity images for each of the plurality of color channels based on the plurality of sub-pixel shifted lower resolution hologram intensity images;
back propagating the super-resolved hologram intensity images for each of the plurality of color channels to an object plane with image processing software to generate an amplitude input image and a phase input image of the sample for each of the plurality of color channels; and
providing a trained deep neural network that is executed by image processing software using one or more processors of a computing device and configured to receive the amplitude input image and the phase input image of the sample for each of the plurality of color channels and output a color output image of the sample.

2. The method of claim 1, wherein the plurality of color channels comprises three color channels.

3. (canceled)

4. The method of claim 1, wherein simultaneous illumination of the sample comprises illuminating the sample simultaneously with three different wavelengths of illumination.

5. The method of claim 4, wherein the three different wavelengths comprise 450 nm, 540 nm, and 590 nm.

6. The method of claim 1, wherein the plurality of sub-pixel shifted lower resolution hologram intensity images are obtained by moving the image sensor in an x, y plane coupled to a moveable stage.

7. The method of claim 1, wherein the plurality of sub-pixel shifted lower resolution hologram intensity images are obtained by moving a sample holder holding the sample in an x, y plane.

8. The method of claim 1, wherein the plurality of sub-pixel shifted lower resolution hologram intensity images are obtained by selective illumination of light sources from an array of light sources.

9. The method of claim 1, wherein the plurality of sub-pixel shifted lower resolution hologram intensity images are obtained by moving an illumination source in a plane or by using illumination from a plurality of illumination sources.

10. The method of claim 1, wherein the sample comprises stained tissue, labeled tissue, or stained cytology slides.

11. (canceled)

12. The method of claim 1, further comprising digitally stitching with image processing software a plurality of color output images into a larger output image.

13. The method of claim 12, wherein the larger output image comprises a field-of-view comprising at least 10 mm² and wherein the larger output image is generated in under 10 minutes.

14. The method of claim 12, wherein the trained deep neural network outputs the color output image of the sample within several minutes of receiving the amplitude input image(s) and the phase input image(s) of the sample.

15. The method of claim 1, wherein the trained deep neural network is trained using a Generative Adversarial Network (GAN) model.

16. A system for performing color image reconstruction of a super-resolved holographic image of a sample comprising: a computing device having image processing software executed thereon, the image processing software comprising a trained deep neural network that is executed using one or more processors of the computing device, wherein the trained deep neural network is trained with a plurality of training images or image patches from a super-resolved hologram of the image of the sample and corresponding ground truth or target color images or image patches, the trained deep neural network configured to receive one or more super-resolved holographic images of the sample generated by the image processing software from multiple low-resolution images of the sample obtained with simultaneous illumination of the sample at a plurality of illumination wavelengths and output a reconstructed color image of the sample.

17. The system of claim 16, wherein the corresponding ground truth or target color images are numerically computed.

18. The system of claim 16, wherein the corresponding ground truth or target color images are obtained from brightfield color images of the same samples.

19. The system of claim 16, further comprising a microscope device that obtains multiple low-resolution images of the sample, the microscope device comprising a sample holder for holding the sample, a color image sensor, and one or more light sources emitting light at the plurality of wavelengths.

20. The system of claim 16, wherein the microscope device comprises a moveable stage configured to move one or both of the color image sensor and/or sample holder in an x, y plane to obtain the multiple low-resolution images of the sample.

21. The system of claim 19, wherein the plurality of one or more light sources comprise an array of light sources.

22. (canceled)

23. A system for performing color image reconstruction of a one or more super-resolved holographic image(s) of a sample comprising:
a lensfree microscope device comprising a sample holder for holding the sample, a color image sensor, and one or more optical fiber(s) or cable(s) coupled to respective different colored light sources configured to simultaneously emit light at a plurality of wavelengths;
at least one of a moveable stage or an array of light sources configured to obtain sub-pixel shifted lower resolution hologram intensity images of the sample; and
a computing device having image processing software executed thereon, the image processing software comprising a trained deep neural network that is executed using one or more processors of the computing device, wherein the trained deep neural network is trained with a plurality of training images or image patches from a super-resolved hologram of the image of the sample and corresponding ground truth or target color images or image patches generated from hyperspectral imaging or brightfield microscopy, the trained deep neural network configured to receive one or more super-resolved holographic images of the sample generated by the image processing software from the sub-pixel shifted lower resolution hologram intensity images of the sample obtained with simultaneous illumination of the sample and output a reconstructed color image of the sample.

24. (canceled)
